(19) United States
(12) Patent Application Publication
(10) Pub. No.: US 2005/0105124 A1
(43) Pub. Date: May 19, 2005

(54) Image processing device, image processing method, image processing program, and computer-readable recording medium on which the program is recorded

(75) Inventor: Kenji Ogasawara, Toda-shi (JP)

Correspondence Address: Barry E. Bretschneider;Morrison & Foerster LLP, 1650 Tysons Boulevard, Suite 300, McLean, VA, 22102, US

(73) Assignee: Konica Minolta Business Technologies, Inc., Chiyoda-ku (JP)

(21) Appl. No.: 10/770,465

(22) Filed: Feb. 4, 2004

(30) Foreign Application Priority Data
Nov. 14, 2003 (JP) 2003-385041

(51) Int. Cl. G06F 15/00

(52) U.S. Cl. 358/1.15; 358/1.16

(57) ABSTRACT

Printer 1 monitors the operating status of the CPU, judges that the compression process execution condition is satisfied when no printing process is being executed, or when executing the compression process simultaneously while a portion of the printing process is being executed does not meaningfully reduces the speed of printing process, compresses uncompressed bitmap data after printing process, and stores it on a hard disk. Since printer 1 executes compression using the spare time during the printing process, it does not cause any delay in the printing process due to overlapping of the printing process and the compression process.

This application is based on Japanese Patent Application No. 2003-385041 filed on Nov. 14, 2003 the contents of which are hereby incorporated by reference.

### BACKGROUND OF THE INVENTION

1. Field of the Invention

The invention relates to an image processing device that allows processed image data to be compressed before storage for future reuses.

2. Description of Related Art

Printing devices for storing in memory devices such as hard disks image data that are processed for printing (“bitmap data”) for future reuses have been known (e.g., JP-9-181892A). Such a printing device can reduce the processing time substantially when reprinting a printing data because it is not necessary to receive and rasterize the same printing data again as it can print it reusing the image data for said printing data already stored in the memory device. Also, in such a printing device, it is common to compress image data when storing it in the memory device for future reuse in order to save the space it occupies in the memory device, and expand it again when reusing it.

However, said prior art had a problem that the printing process may experience a significant delay due to the fact that the compression process, a heavier load to the processor, causes the printing process to slow down, when the compression process of the previous printing overlaps with the printing process of the current printing as the printing process is executed in the same series of procedures with the compression and storage processes of the image data.

### SUMMARY OF THE INVENTION

The invention was made in view of the abovementioned problem of the prior art in image processing devices where image data after image processing are compressed and stored for future reuses and it is intended to provide an image processing device that prevents any delay due to overlapping of the image processing and the compression process by means of executing the compression process using the spare times in the image processing.

Said objective of the present invention can be accomplished by the following means:
(1) An image processing device comprising: a processing unit for processing image data; a judging unit for judging whether operating status of said processing unit satisfies a predetermined compression process execution condition or not; and a compression unit for compressing image data processed by said processing unit when said judging unit judges that operating status of said processing unit satisfies said compression process execution condition.

(2) An image processing method comprising: a processing step of processing image data; a judging step of judging whether operating status of said processing step satisfies a predetermined compression process execution condition or not; and a compression step of compressing image data processed by said processing step when said judging steps judges that operating status of said processing step satisfies said compression process execution condition.

(3) An image processing program for causing an image processing device to execute: a processing step of processing image data; a judging step of judging whether operating status of said processing step satisfies a predetermined compression process execution condition or not; and a compression step of compressing image data processed by said processing step when said judging steps judges that operating status of said processing step satisfies said compression process execution condition.

(4) A computer readable recording medium on which the image processing program as described above is recorded.

### BRIEF DESCRIPTION OF THE DRAWINGS

FIG. 1 is a block diagram showing the entire constitution of an image processing system wherein an image processing device according to an embodiment of the present invention is applied.

FIG. 2 is a block diagram showing the constitution of printer 1 shown in FIG. 1.

FIG. 3 is a flowchart showing the sequence of printing process by means of printer 1.

FIG. 4 is a flowchart showing the sequence of image data compression process of printer 1.

FIG. 5 is a flowchart showing the sequence of image data expansion process of printer 1.

### DESCRIPTION OF THE PREFERRED EMBODIMENTS

The preferred embodiments of the invention will be described in detail below with reference to the accompanying drawings.

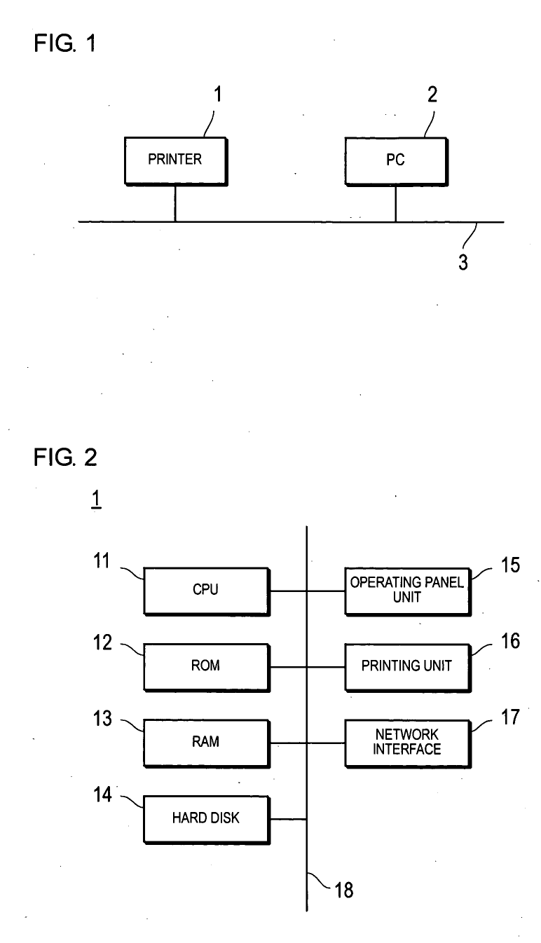

FIG. 1 is a block diagram showing the entire constitution of an image processing system wherein an image processing device according to an embodiment of the present invention is applied. As shown in FIG. 1, the printing system according to this embodiment is equipped with a printer 1 as an image processing device and a PC (personal computer) 2 as an image data transmission device, which are connected via a network 3 to communicate with each other. The types and the number of equipment to be connected to network 3 are not limited to those shown in FIG. 1. Also, printer 1 and PC 2 can be connected directly without recourse to network 3.

FIG. 2 is a block diagram showing the constitution of printer 1 according to the present embodiment. As shown in FIG. 2, printer 1 contains a CPU 11, a ROM 12, a RAM 13, a hard disk 14, an operating panel unit 15, a printing unit 16, and a network interface 17, all of which are interconnected by a bus 18 for exchanging signals.

CPU 11 controls various parts indicated above and executes various arithmetic processes according to a program. ROM 12 stores various programs and parameters for controlling basic operations of printer 1. RAM 13 stores programs and data temporarily as a working area. Hard disk 14 is used for storing various programs and parameters or for temporarily storing image data obtained by image processing.

Operating panel unit 15 consists of a touch panel, fixed keys, indicator lamps and others used for various inputting and displaying purposes.

Printing unit 16 prints image data (bitmap data) on recording media such as paper by means of the electronic photography system going through each step of charging, exposing, developing, transferring, and fixing.

Network interface 17 is an interface to connect with a network for communicating with other devices on the network using standards such as Ethernet®, Token Ring, FDDI, etc.

Printer 1 may contain constitutional elements other than those described above, or may not include a portion of the abovementioned elements.

PC 2 is a computer, such as a personal computer, workstation or server, capable of preparing printing data in the descriptive language format defined by printer 1 and transmitting it with a printing order to printer 1 via network 3.

Network 3 can be a LAN connecting computers and network equipment according to standards such as Ethernet®, Token Ring, and FDDI, or a WAN that consists of several LANs connected by a dedicated line.

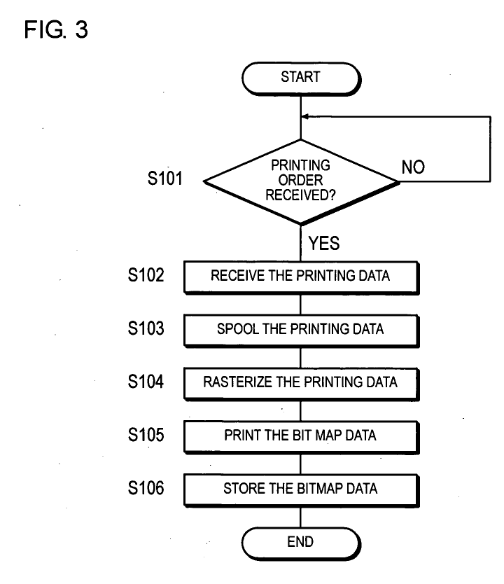

Next, the outline of the image processing system according to this embodiment will be described below. FIG. 3 is a flowchart showing the sequence of printing process by means of printer 1 in the present embodiment. The algorithm indicated by the flowchart of FIG. 3 is stored as a control program on ROM 12 of printer 1, readout by RAM 13, and executed by CPU 11 when the operation starts.

In FIG. 3, printer 1 awaits for a printing order to arrive from PC2 (S101: No). As a printing order is received from PC 2 via network 3 and network interface 17 (S101: Yes), printing data is also received from PC 2 (S102), and the received printing data is spooled in RAM 13 (S103). The printer translates the page descriptive language of the spooled printing data, rasterizes it per each page (S104), prints out the obtained bitmap data on a recording medium such as paper by means of printing unit 16 (S105), and stores the bitmap data after the printing process on hard disk 14 (S106).

The printing data to be received from PC 2 needs not to be described in a page descriptive language, but rather can be a data obtained by compressing an image data such as a bit map data. In such a case, the expansion process of a printing data is performed in step S104.

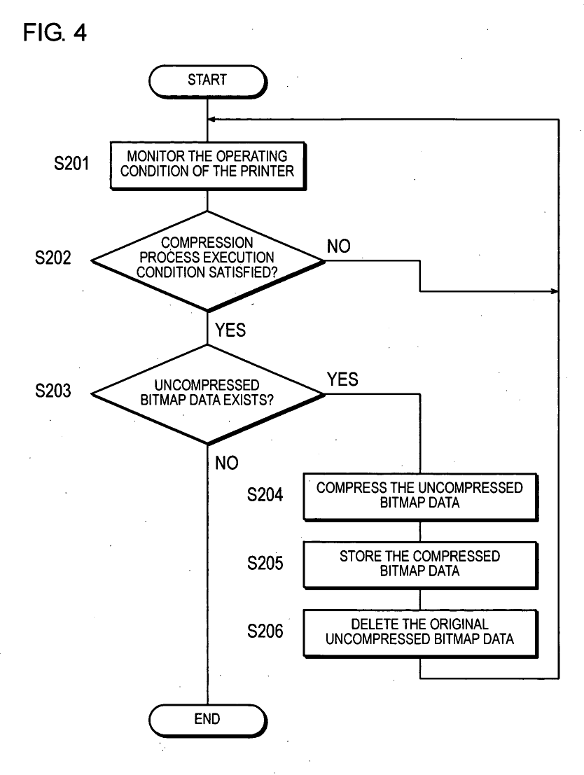

FIG. 4 is a flowchart showing the sequence of image data compression process of printer 1 of this embodiment. The algorithm indicated by the flowchart of FIG. 4 is stored as a control program on ROM 12 of printer 1, read out by RAM 13, and executed by CPU 11 when the operation starts.

In FIG. 4, printer 1 monitors the operating status of CPU 11 (S201), and makes a judgment whether the operating status of CPU 11 satisfies the compression process execution condition (S202). The compression process execution condition of this embodiment is that CPU 11 is not executing the printing process, or that the printing process speed does not reduce even if the compression is executed simultaneously while CPU 11 is executing a portion of the printing process. More specifically, said compression process execution condition can be defined as that CPU 11 is executing neither the spooling process, rasterizing process, printing process, compressing process, nor expanding process, nor a combination of any of them, but the compression process execution condition is normally affected by the capacities of CPU 11, RAM 13, and hard disk 14 so that it can be set up arbitrarily to suit the hardware constitution of printer 1.

Thus, printer 1 of this embodiment executes the compression process using the spare time during the image process and does not cause any delay due to the overlapping of the image process with the compression process, so that it is possible to store and reuse the bitmap data obtained as a result of the printing process with an extremely high efficiency without sacrificing the speed of the entire printing process even if the capacity of CPU 11 and the capacity of hard disk 14 are limited.

The monitoring of the operating status of CPU 11 in step S201 is not always executed, but rather can be executed at a certain interval or periodically according to a set schedule, or at an appropriate timing selected according to the system load, etc.

If the operating status of CPU 11 in step 202 does not satisfy the compression process execution condition (S202: No), the operating status of CPU 11 will be monitored continuously (S201). If the operating status of CPU 11 satisfies the compression process execution condition (S202: Yes), a judgment is made as to whether any bitmap data obtained after the printing process and stored in hard disk 14 is uncompressed (203), and if there is no uncompressed bitmap data exists in hard disk 14 S203: No), the image data compression process is terminated.

On the other hand, if there are some uncompressed bitmap data stored in hard disk 14 (S203: Yes), the printer reads said uncompressed bitmap out to RAM 13, compresses it according to a predetermined compression method (S204), stores the compressed bitmap data on hard disk 14 (S205), and then deletes the original uncompressed bitmap data from hard disk 14 (S206). The printer repeats the same procedure until there is no more uncompressed bitmap data on hard disk 14 (S201 through S203: Yes, and S204 through S206); when it reaches a point that there is no more uncompressed bitmap data on hard disk 14 (S203: No), it terminates the image data compression process.

It is not necessary to delete the original uncompressed data from hard disk 14 after compressing the uncompressed bit map data, so that it can be constituted to store both the compressed data and the uncompressed data, in which case step S206 is not necessary.

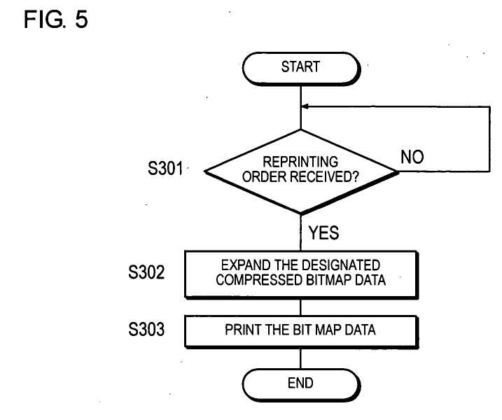

FIG. 5 is a flowchart showing the sequence of image data expansion process of printer 1 of this embodiment. The algorithm indicated by the flowchart of FIG. 5 is stored as a control program on ROM 12 of printer 1, read out by RAM 13, and executed by CPU 11 when the operation starts.

In FIG. 5, printer 1 awaits for a reprinting order to arrive from PC 2 (S301: No). When it receives a reprinting order from PC 2 via network 3 and network interface 17 (S301: Yes), it reads and expands the compressed bitmap data designated by the reprinting order from hard disk 14 on RAM 13 (S302), outputs the obtained bitmap data on a recording medium such as paper by means of printing unit 16 (303), and completes the reprinting process.

The reprinting order does not necessarily have to come from PC 2, but rather can originate from devices other than the device that transmitted the original printing data.

The invention is not limited to the embodiment described above, but also can be changed in various ways within the scope of the claims. For example, the image processing device of the present invention can be applied to a printer controller in a printing system in which the printer controller and the printer engine are provided as separate units. In this case, the bitmap data is transmitted to the printer engine instead of the obtained bitmap data being printed in steps S105 or S303.

Moreover, the image processing device of this invention can be applied to various image processing devices other than the printer such as multiple function peripheral equipment (MFP) having a printing capability, e.g., digital copying machines and facsimile devices, and computers, e.g., personal computers, work stations, and servers.

The image processing device according to this invention can be realized by a dedicated hardware circuit for executing the abovementioned steps, or by causing a CPU to execute a program where said steps are described. If the present invention is to be materialized by the latter means, said programs for operating the image processing device can be provided by computer-readable recording media such as a floppy® disk and CD-ROM, or can be provided on-line via a network such as the Internet. In this case, the program recorded on the computer readable recording medium is normally transferred to and stored in a memory device such as ROM and a hard disk. The program can also be provided as independent application software or can be built into the software of the image processing device as a part of its function.

As can be seen from the above, the image processing device of this invention is to use the spare time during the image process for the compression process, more specifically, to monitor the operating status of the device and to execute the compression process only when no image process is being executed, or when executing the compression process while a portion of the image process is executed simultaneously does not essentially reduce the processing speed, avoiding the process slow down due to the overlap of the image process and the compression process, so that it allows us to compress and store the processed image data without sacrificing the processing speed of the overall image process even when the capacities of the CPU and hard disk are low, thus making it possible to store and reuse the image data extremely efficiently.

1. An image processing device comprising:
a processing unit for processing image data;
a judging unit for judging whether operating status of said processing unit satisfies a predetermined compression process execution condition or not; and
a compression unit for compressing image data processed by said processing unit when said judging unit judges that operating status of said processing unit satisfies said compression process execution condition.

2. An image processing device described in claim 1 wherein
said judging unit judges that operating status of said processing unit satisfies a predetermined compression process execution condition when no processing is being executed by said processing unit, or when executing the compression process by means of said compression unit simultaneously while a portion of the process is being executed by means of said processing unit does not meaningfully reduces the processing speed by said processing unit.

3. Image processing device described in claim 1 further comprising:
a memory unit for storing image data compressed by said compression unit;
and an expansion unit for expanding image data stored in said memory unit when reprocessing image data by means of said processing unit; wherein
said processing unit reprocesses the image data expanded by said expansion unit.

4. An image processing device described in claim 1 wherein said processing unit comprises:
a spooling unit for spooling image data;
a rasterizing unit for rasterizing image data spooled by said spooling unit;
and an image forming unit for image-forming the image data rasterized by said rasterizing unit.

5. An image processing device described in claim 1 wherein said processing unit comprises:
a spooling unit for spooling image data;
a rasterizing unit for rasterizing image data spooled by said spooling unit;
and a transmitting unit for transmitting the image data rasterized by said rasterizing unit.

6. An image processing method comprising:
a processing step of processing image data;
a judging step of judging whether operating status of said processing step satisfies a predetermined compression process execution condition or not; and
a compression step of compressing image data processed by said processing step when said judging steps judges that operating status of said processing step satisfies said compression process execution condition.

7. An image processing method described in claim 6 wherein
said judging step judges that operating status of said processing step satisfies a predetermined compression process execution condition when no processing is being executed by said processing step, or when executing the compression process by means of said compression step simultaneously while a portion of the process is being executed by means of said processing step does not meaningfully reduces the processing speed by said processing step.

8. Image processing method described in claim 6 further comprising:
a memory step of storing image data compressed by said compression step;
and an expansion step of expanding image data stored in said memory step when reprocessing image data by means of said processing step; wherein
said processing step reprocesses image data expanded by said expansion step.

9. An image processing method described in claim 6 wherein said processing step comprises:
a spooling step of spooling image data;
a rasterizing step of rasterizing image data spooled by said spooling step; and
an image forming step of image-forming the image data rasterized by said rasterizing step.

10. An image processing method described in claim 6 wherein said processing step comprises:
a spooling step of spooling image data;
a rasterizing step of rasterizing image data spooled by said spooling step; and
a transmitting step of transmitting the image data rasterized by said rasterizing step.

11. An image processing program for causing an image processing device to execute:
a processing step of processing image data;
a judging step of judging whether operating status of said processing step satisfies a predetermined compression process execution condition or not; and
a compression step of compressing image data processed by said processing step when said judging steps judges that operating status of said processing step satisfies said compression process execution condition.

12. An image processing program described in claim 11 wherein
said judging step judges that operating status of said processing step satisfies a predetermined compression process execution condition when no processing is being executed by said processing step, or when executing the compression process by means of said compression step simultaneously while a portion of the process is being executed by means of said processing step does not meaningfully reduces the processing speed by said processing step.

13. Image processing program described in claim 11 further causing an image processing device to execute:
a memory step of storing image data compressed by said compression step;
and an expansion step of expanding image data stored in said memory step when reprocessing image data by means of said processing step; wherein
said processing step reprocesses image data expanded by said expansion step.

14. An image processing program described in claim 11 wherein said processing step comprises:
a spooling step of spooling image data;
a rasterizing step of rasterizing image data spooled by said spooling step; and
an image forming step of image-forming the image data rasterized by said rasterizing step.

15. An image processing program described in claim 11 wherein said processing step comprises:
a spooling step of spooling image data;
a rasterizing step of rasterizing image data spooled by said spooling step; and
a transmitting step of transmitting the image data rasterized by said rasterizing step.

16. A computer readable recording medium on which the image processing program as described in claim 11 is recorded.
